(19) United States
(12) Patent Application Publication
(10) Pub. No.: US 2024/0369173 A1
(43) Pub. Date: Nov. 7, 2024

(54) TOPOLOGICAL INSULATION DEVICE HAVING NEGATIVE THERMAL EXPANSION

(71) Applicant: ZHEJIANG UNIVERSITY, Zhejiang (CN)

(72) Inventors: Ying LI, Zhejiang (CN); Dong WANG, Zhejiang (CN); Chaoran JIANG, Zhejiang (CN); Xiangying SHEN, Zhejiang (CN); Jiping HUANG, Zhejiang (CN)

(73) Assignee: ZHEJIANG UNIVERSITY, Zhejiang (CN)

(21) Appl. No.: 18/773,588

(22) Filed: Jul. 16, 2024

Related U.S. Application Data
(63) Continuation of application No. PCT/CN2022/072679, filed on Jan. 19, 2022.

(51) Int. Cl. F16L 59/00; H01B 17/56

(52) U.S. Cl. CPC F16L 59/00; H01B 17/56

(57) ABSTRACT

The present invention belongs to the field of thermal functional devices. Provided is a topological insulation device having negative thermal expansion. In the topological insulation device, three assemblies of different properties are constructed using assembly units of special geometric structures, and then different assemblies are assembled to form an outer heat-conduction ring and a thermal insulation region, which is wrapped by the outer heat-conduction ring, so that the device has the characteristics of surface thermal conduction and internal thermal insulation, and an edge state and a topological protection property, which are similar to those of an electrical topological insulator, are realized in a macroscopic heat conduction process.

### CROSS-REFERENCE TO RELATED APPLICATION

This application is a continuation of international application of PCT application serial no. PCT/CN2022/072679 filed on Jan. 19, 2022. The entirety of the above mentioned patent application is hereby incorporated by reference herein and made a part of this specification.

### TECHNICAL FIELD

The present invention belongs to the field of thermal functional devices, and specifically relates to a topological insulation device having negative thermal expansion.

### DESCRIPTION OF RELATED ART

Metamaterials are a class of artificially designed structures that do not exist naturally in nature but are formed by natural materials. Generally, metamaterials are formed by artificially-designed basic units, and these basic units often enable the metamaterials to possess counterintuitive physical properties beyond those of the natural materials that make up the structure.

In recent years, topological materials have attracted widespread attention due to their non-trivial topological properties caused by topological phase transitions. The most typical and well-known example is topological insulators. A topological insulator is a material whose band structure is an insulator when electrons are inside it, but its surface contains a series of specific conductive states. This means that electrons can only move along the surface of the material, thus exhibiting strange properties of internal insulation and surface conduction.

Similar to metamaterials, the range of topological materials has also expanded from naturally occurring topological insulator materials to electromagnetic and acoustic materials composed of artificial units. However, the design and application of topological materials are still limited to wave systems. For the macroscopic heat transfer process, its physical laws are described by the diffusion equation rather than the wave equation. Therefore, it is generally believed that there is no topological property in the macroscopic heat transfer process. However, if an unconventional topological insulator can be achieved in the macroscopic heat transfer process, new ideas and feasibility for further studying the topological properties of diffusion systems can be provided.

### SUMMARY

The present invention aims to solve the defect that topological properties cannot be achieved in the macroscopic heat transfer process in conventional devices and provides a topological insulation device having negative thermal expansion. Through a special structural design, this topological insulation device has heat conduction capability on the surface of the device, but cannot conduct heat inside, so that edge states and topological protection properties similar to those of electrical topological insulators during the macroscopic heat conduction process are achieved, and new ideas and feasibility for further studying the topological properties of diffusion systems are thus provided.

To achieve the above, the specific technical solutions to be adopted by the present invention are as follows:

A topological insulation device having negative thermal expansion including a first assembly, a second assembly, a third assembly, and a heat-insulating substrate is provided, and the three assemblies are constructed by different numbers of assembly units.

Each of the assembly units is a broken-line-shaped structure formed by a first rod segment, a second rod segment, a third rod segment, and a fourth rod segment connected in sequence, and the four rod segments all have the positive thermal expansion property when heated and have the same linear expansion coefficient. One end of the first rod segment is a free end, the other end of the first rod segment is connected to one end of the second rod segment through a first connection point, the other end of the second rod segment is connected to one end of the third rod segment through a second connection point, the other end of the third rod segment is connected to one end of the fourth rod segment through a third connection point, and the other end of the fourth rod segment is a free end. In a non-working state, the first rod segment and the second rod segment are mirror symmetrical to the third rod segment and the fourth rod segment respectively, the free end of the first rod segment, the second connection point, and the free end of the fourth rod segment are located at three corner points of a square, and the first rod segment and the fourth rod segment are located on two adjacent sides of the same square.

The first assembly is formed by four assembly units spliced into a centrosymmetric structure, and the first rod segment of any assembly unit is integrated with and is connected to the fourth rod segment of the adjacent assembly unit as a whole to act as a negative thermal expansion segment.

The second assembly is formed by two assembly units spliced into a mirror-symmetric structure, and the first rod segment of one assembly unit is integrated with and is connected to the fourth rod segment of the adjacent assembly unit as a whole to act as a negative thermal expansion segment. The first rod segment and the fourth rod segment that are unconnected in each of the two assembly units both act as positive thermal expansion segments.

The third assembly is formed by a single assembly unit, in which the first rod segment and the fourth rod segment both act as positive thermal expansion segments.

The three assemblies are assembled on the substrate to form an outer heat-conduction ring and a thermal insulation region wrapped by the outer heat-conduction ring. A plurality of second assemblies and a plurality of third assemblies are spliced into a ring shape sequentially to form the outer heat-conduction ring, and the thermal insulation region is formed by a plurality of the first assemblies arranged in a periodic array. The second connection points of all assemblies in the outer heat-conduction ring and the thermal insulation region are fixed on the substrate and cannot be moved, and both the first connection point and the third connection point can move freely. In the outer heat-conduction ring, any two adjacent assemblies are collinearly or parallelly connected through their positive thermal expansion segments. In the thermal insulation region, only one negative thermal expansion segment in each of any two adjacent first assemblies is collinearly connected to another only one negative thermal expansion segment. Further, one negative thermal expansion segment in each of the first assemblies located at an edge of the thermal insulation region and a corresponding assembly in the outer heat-conduction ring is also collinearly connected to each other.

Preferably, in the outer heat-conduction ring, the third component is provided at a corner position for connection, while the remaining straight line segments are connected by the second assembly.

Preferably, surfaces of the first rod segment, the second rod segment, the third rod segment, and the fourth rod segment are all conductive, each rod segment generates Joule heat after conduction, and the substrate is not conductive.

Further, the first rod segment, the second rod segment, the third rod segment, and the fourth rod segment are all made of a multi-layer composite material, and a skeleton of the composite material is made of a thermal expansion material and a conductive layer is wrapped outside the skeleton.

Further, the thermal expansion material is nickel alloy, copper alloy, or nylon.

Further, the conductive layer is graphene paint coated on the skeleton and/or conductive tape wrapped around the skeleton.

Further, the first assembly, the second assembly, and the third assembly are all formed through integrated processing, and the first rod segment and the fourth rod segment in the negative thermal expansion segments are non-spliced integrated rod segments.

Further, the first assembly, the second assembly, and the third assembly are all processed using 3D printing technology.

Preferably, in the outer heat-conduction ring and the thermal insulation region, a gap between any two assemblies collinearly connected through the negative thermal expansion segments is under conductance control based on a temperature threshold. When temperatures of the two assemblies themselves are not higher than the temperature threshold, the two negative thermal expansion segments collinearly connected are in a thermal conduction state. When the temperatures of the two assemblies themselves are higher than the temperature threshold, the two negative thermal expansion segments that are collinearly connected originally are separated and are in a thermal disconnection state.

Further, the temperature threshold is room temperature.

Compared to the related art, the present invention exhibits the following beneficial effects:

A topological insulation device based on a negative thermal expansion structure is designed in the present invention based on the design idea of a negative thermal expansion structure. In the topological insulation device, three assemblies of different properties are constructed using assembly units of special geometric structures, and then different assemblies are assembled to form an outer heat-conduction ring and a thermal insulation region, which is wrapped by the outer heat-conduction ring, so that the device has the properties of surface thermal conduction and internal thermal insulation, and an edge state and a topological protection property, which are similar to those of an electrical topological insulator, are realized in a macroscopic heat conduction process. In addition, the further designed electrical topological insulation device in the present invention combines the thermal expansion phenomenon with the thermal effect of the resistor to achieve the topological edge state of heat flow and direct current, reflecting the unconventional properties of electrical insulation in the body and electrical conduction on the surface.

### BRIEF DESCRIPTION OF THE DRAWINGS

FIG. 1 illustrates a schematic diagram of an assembly unit structure in a topological insulation device.

FIG. 2 illustrates structural diagrams and schematic diagrams of thermal deformation effect of different types of assemblies, where (a) and (c) respectively are schematic diagrams of a first assembly and a second assembly, and (b) and (d) respectively are schematic diagrams of an arrow-shaped structure and the deformation of the second assembly before and after being heated.

FIG. 3 illustrates diagrams demonstrating local results of the topological insulation device under finite element simulation in the present invention, where (a) is a schematic diagram of a local device simulation structure at a boundary position, (b) demonstrates expansion of the second assembly and the first assembly when heated, a hollow part is an original shape and a black part is a deformed shape, (c) is a temperature distribution after high temperature is applied to a surface and inside of the device, and (d) is stress distribution after high temperature is applied to the surface and inside of the device.

FIG. 4 illustrates diagrams demonstrating correspondence between a device structure and a SSH model and results of the present invention, where (a) is a corresponding relationship between the structure of the present invention and the SSH model, (b) is a schematic diagram of the SSH model, (c) is an energy band structure of a full periodic structure of the SSH model corresponding to the present invention, and (d) is an energy band structure of a half periodic structure of the SSH model corresponding to the present invention.

FIG. 5 illustrates a schematic diagram of a topological insulation device sample designed in an example of the present invention.

FIG. 6 illustrates test effect diagrams of the topological insulation device sample in an example of the present invention, where (a) is temperature distribution when a heat source is applied to the surface of the device, and (b) is temperature distribution when the heat source is applied to the inside of the device.

### DESCRIPTION OF THE EMBODIMENTS

In order to make the above objects, features and advantages of the present invention more clearly understood, the specific embodiments of the present invention will be described in detail below with reference to the accompanying drawings. In the following description, numerous specific details are set forth in order to provide a thorough understanding of the present invention. However, the present invention can be implemented in many other ways than those described herein, and a person having ordinary skill in the art can make similar modifications without departing from the meaning of the present invention. Accordingly, the present invention is not limited by the specific examples disclosed below. The technical features in the various embodiments of the present invention may be combined accordingly as long as they do not conflict with each other.

In the description of the present invention, it should be understood the terms “first” and “second” are only used for differentiating and descriptive purposes and cannot be understood as indicating or implying relative importance or implicitly indicating the number of indicated technical features. Thus, the features defined with “first” and “second” may explicitly or implicitly include at least one of these features.

In a preferred embodiment of the present invention, a topological insulation device having negative thermal expansion is provided, and core components forming the topological insulation device include a first assembly, a second assembly, a topological insulation device having negative thermal expansion, and a heat-insulating substrate. The substrate acts as an installation basis for the three assemblies, and there can be a plurality of first assemblies, a plurality of second assemblies, and a plurality of third assemblies installed on the substrate, and the assemblies are combined and spliced into a corresponding plane shape of the device.

In the present invention, the three assemblies are all formed by different numbers of assembly units, so a specific structure and working principles of a single assembly unit is to be described in detail in the following paragraphs.

It should be noted that the positive thermal expansion mentioned in the present invention is normal thermal expansion, which is characterized by the volume expansion of the material after being heated. For rods, the macroscopic manifestations are mainly the increase in the diameter of the rod segment and the elongation of the length, and what is mainly used in the present invention is the thermal expansion property of the elongation in length of the rod segment after being heated. Negative thermal expansion in the present invention means that when the temperature changes, changes in the length of each rod segment of the assembly unit may cause geometric changes in the structure of the entire assembly unit. Macroscopically, it manifests as a portion of position moving toward the center of the unit, resulting in a reduction in the volume or area of the entire unit, that is, a phenomenon of thermal shrinkage. This phenomenon of thermal shrinkage is opposite to the conventional thermal expansion, so it is called negative thermal expansion.

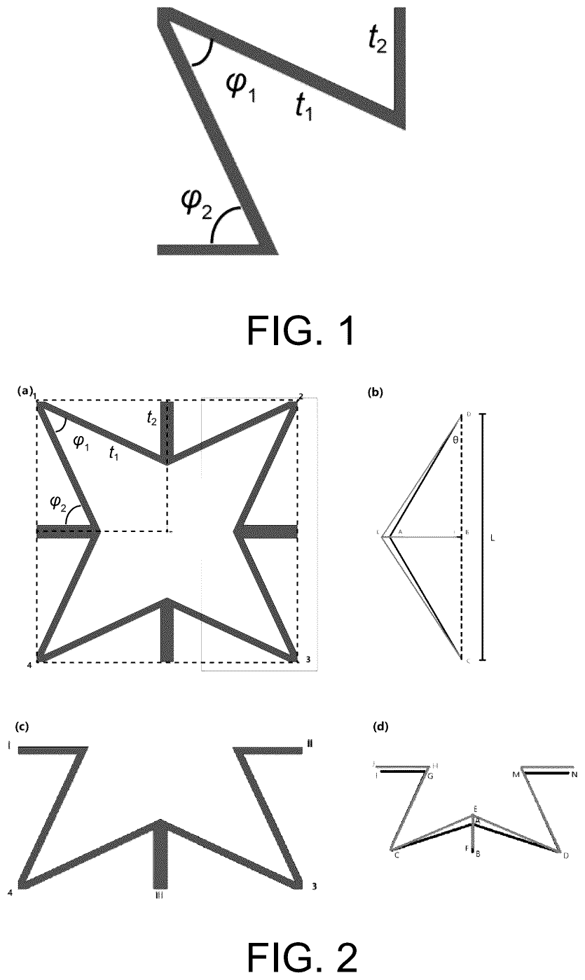

As shown in FIG. 1, it is a schematic structural diagram of a single assembly unit. The single assembly unit is a broken-line-shaped structure formed by a first rod segment, a second rod segment, a third rod segment, and a fourth rod segment connected in sequence. Further, the four rod segments all have the positive thermal expansion property. The so-called positive thermal expansion property refers to the normal thermal expansion property that the lengths of the rod segments may become longer after being heated. In addition, linear expansion coefficients of the four rod segments are the same. The linear expansion coefficient refers to the elongation of the rod segment per unit length when the temperature increases by 1 degree Celsius. Herein, one end of the first rod segment is a free end. The other end of the first rod segment is connected to one end of the second rod segment, and this connection point is called a first connection point, so the other end of the first rod segment and one end of the second rod segment are connected through the first connection point. Similarly, the other end of the second rod segment is connected to one end of the third rod segment, and this connection point is called a second connection point, so the other end of the second rod segment and one end of the third rod segment are connected through the second connection point. The other end of the third rod segment is connected to one end of the fourth rod segment, and this connection point is called a third connection point, so the other end of the third rod segment and one end of the fourth rod segment are connected through the third connection point. The other end of the fourth rod segment is a free end.

It should be noted that the materials used for the four rod segments in the assembly unit in the present invention are not limited, as long as they have a certain linear expansion coefficient. In general, the greater the linear expansion coefficient of a rod segment, the more sensitive its response may be, so materials with larger linear expansion coefficients, such as alloys or composite materials, may be adopted to be processed into different rod segments.

In addition, it should be noted that a material of the substrate in the present invention is not limited, as long as it has heat-insulating properties.

For the ease of description, an initial state in which the assembly unit is not heated is called a non-working state, and the initial state in which the assembly unit is not heated may generally be the state when the assembly unit is at room temperature.

With reference to FIG. 1 again, in the non-working state, the first rod segment and the second rod segment are mirror symmetrical to the third rod segment and the fourth rod segment respectively. Further, the free end of the first rod segment, the second connection point, and the free end of the fourth rod segment are located at three corner points of a square, and the first rod segment and the fourth rod segment are located on two adjacent sides of the same square.

Therefore, according to the geometric relationship, it can be seen that if an angle between the first rod segment and the second rod segment is represented as φ₂, then an angle between the third rod segment and the fourth rod segment is also φ₂, and if an angle between the second rod segment and the third rod segment is represented as φ₁, then φ₁ and φ₂ satisfy 2φ₂=φ₁+π/2. Further, if lengths of the first rod segment and the fourth rod segment are both represented as t₂ and lengths of the second rod segment and the third rod segment are both represented as t₁, then t₁ and t₂ satisfy t₂=t₁ cos φ₂.

Based on the single assembly unit shown in FIG. 1, three different assemblies including the first assembly, the second assembly, and the third assembly may be formed, and structures of these three assemblies are described in detail in the following paragraphs.

As shown in (a) of FIG. 2, the first assembly is formed by four assembly units spliced into a centrosymmetric structure. The small square dashed box in the upper left corner shows a single assembly unit, and the overall large square dashed box shows the first assembly formed by splicing four assembly units. Herein, when the four assembly units are spliced, each angle 41 faces a center point of the first assembly, the first rod segment of any assembly unit is integrated with and is connected to the fourth rod segment of the adjacent assembly unit as a whole, and the first rod segment and the fourth rod segment connected as a whole form a negative thermal expansion segment. The entire first assembly finally presents a two-dimensional shape formed by a four-pointed star and four negative thermal expansion segments. The four corner points of the four-pointed star are located at the four corner points of a square, and the four negative thermal expansion segments face four different directions. For ease of description, the two-dimensional shape may also be called a square-star structure in the present invention.

It should be noted that in the present invention, the integration of two rod segments may mean that the two rod segments are placed side by side or are completely overlapped in space, as long as two rod segments of the same length can be connected into an integrated rod segment that still maintains the same length.

As shown in (c) of FIG. 2, the second assembly is formed by two assembly units spliced into a mirror-symmetric structure. The first rod segment of one assembly unit is integrated with and is connected to the fourth rod segment of the adjacent assembly unit as a whole to act as a negative thermal expansion segment. The first rod segment and the fourth rod segment that are unconnected in the two assembly units both act as positive thermal expansion segments. A mirror symmetry plane of the second assembly is exactly the negative thermal expansion segment. The third assembly is formed by a single assembly unit, i.e., as shown in FIG. 1, in which the first rod segment and the fourth rod segment both act as positive thermal expansion segments.

It should be noted that the so-called negative thermal expansion segment in the present invention refers to a functional rod segment that exhibits the aforementioned “negative thermal expansion.” That is, when the entire device is heated, the negative thermal expansion segment moves toward the center of the device, resulting in a reduction in the area or volume of the assembly and showing the macroscopic property of thermal shrinkage. Besides, the so-called positive thermal expansion segment in the present invention refers to a functional rod segment that exhibits the aforementioned “positive thermal expansion.” That is, when the entire device is heated, the positive thermal expansion segment moves away from the center of the device, resulting in an increase in the area or volume of the assembly and showing the macroscopic property of thermal expansion.

In the following paragraphs, the specific principles of the negative thermal expansion segment and the positive thermal expansion segment are described in order to facilitate understanding of their essence.

As shown in (a) of FIG. 2, since all rod segments in the present invention have a certain linear expansion coefficient, the length of each rod segment becomes longer after being heated, and a single rod segment exhibits the normal thermal expansion property. However, in the first assembly, each rod segment is interconnected, and under a specific geometric relationship, the expansion of the rod segment may cause the entire assembly structure to rotate or bend, thereby exhibiting local negative thermal expansion. To be specific, for the first assembly shown in (a) of FIG. 2, if the four second connection points (marked as points 1, 2, 3, and 4 in the figure) constraining the first assembly are fixed, the four corners may not experience any displacement on the substrate when the temperature changes. After the above constraints of fixation are satisfied, the first assembly is regarded as an overall structure, and an effective thermal expansion coefficient of the first assembly may be derived by analogy with the thermal expansion coefficient of ordinary materials.

During the derivation process, the local structure shown by the solid rectangular box on the right side in (a) of FIG. 2 is regarded as an arrow-shaped structure, and the effective thermal expansion coefficient is derived based on this arrow-shaped structure. As shown in (b) of FIG. 2, a maximum span of the arrow-shaped structure is recorded as a side length L, an angle ∠ADB of the square-star structure is set to θ, and the influence of a thickness of the arrow-shaped structure is ignored to simplify the derivation. In (b) of FIG. 2, the deformation of the geometric shape of the arrow-shaped structure is shown before and after the temperature increases. Since points C and D are locked in space, a rod segment AC and a rod segment AD cannot freely extend in an original direction and can only jointly force the point A to move to the left to the point E to release the elongation caused by the increase in temperature. Therefore, the length of a rod segment AB becomesL_{EF}:

$${L}_{EF} = \frac{1}{2} L tan θ ( 1 + αΔ T ) \qquad ( 1 )$$

in the formula, α is the linear expansion coefficient of the rod segment, and ΔT is the increase in temperature.

Further, since a point E translates to the left under the symmetrical action of rod segments CE and DE, a distance between an apex and a bottom edge of the arrow-shaped structure changes from L_{AB} to L_{EB}. The expression for L_{EB} shall be:

$${L}_{EB} = \frac{1}{2} L tan θ ( 1 + \frac{αΔ T}{{sin}^{2} θ} ) \qquad ( 2 )$$

It thus can be known that when the temperature of point B increases, the translation distance to the left is L_{BF}:

$${L}_{BF} = \frac{1}{2} L tan θ \cdot αΔ T {cot}^{2} θ \qquad ( 3 )$$

According to the definition of material thermal expansion coefficient:

$$α = \frac{1}{{L}_{original}} \cdot \frac{Δ L}{Δ T} \qquad ( 4 )$$

in the formula: L_{original} is an original size of a solid material when there is no expansion, and ΔL is elongation of the material when the temperature change is ΔT.

Therefore, according to the definition of material thermal expansion coefficient given by the aforementioned formula (4), it can be concluded that the equivalent thermal expansion coefficient of the arrow-shaped structure is:

$${α}^{′} = - α \cdot {cot}^{2} θ \qquad ( 5 )$$

This shows that the arrow-shaped structure exhibits negative thermal expansion when the temperature increases. That is, for the first assembly, when the temperature increases, the negative thermal expansion segment may move toward the center of the assembly, manifesting as thermal shrinkage.

Similarly, for the second assembly as shown in (c) of FIG. 2, the second assembly lacks of parts compared to the first assembly. In this case, as shown in (d) of FIG. 2, since the two assembly units in the upper part are missing, only the remaining two assembly units form the second assembly, causing points G and N to lose the stress originally provided by the upper part of the structure in a y direction. When the second assembly is heated, the structure shown in (c) of FIG. 2 may be deformed, and the geometry before and after deformation is shown in (d) of FIG. 2. It can be seen from the figure that when a rod segment CG and a rod segment DM are free to expand in a direction of the rod segment itself when the points C and D are restricted by the constraints of fixation. The point G moves to the point H, and the point M also moves symmetrically. Both show positive thermal expansion. Similarly, a rod segment GI and a rod segment MN also show positive thermal expansion, a point I moves to a point J, and a point N also moves symmetrically as well. Points I and II of the structure in (c) of FIG. 2 may expand freely along an x-axis direction when the temperature rises, so the structure may show normal thermal expansion in the x direction, and that the rod segment GI and the rod segment MN are both positive thermal expansion segments. Similar to the first assembly, since the points 3 and 4 still maintain symmetrical fixed constraints, the rod segment CE and the rod segment DE jointly push the rod segment AB to move upward in a y-axis direction after being heated, the point A moves to the point E, and the point B moves to the point F. Therefore, the local structure may show negative thermal expansion that is abnormal in the y direction, and the rod segment AB is a negative thermal expansion segment.

In addition, for the third assembly, it does not have the special spatial geometric constraints seen in the first assembly and the second assembly, so both free ends exhibit positive thermal expansion, and the third assembly only has a positive thermal expansion segment.

In view of the foregoing, the three different assemblies, the first assembly, the second assembly, and the third assembly have different thermal expansion properties, and thus may be used for assembly on the substrate to form a corresponding topological insulation device. This topological insulation device utilizes negative thermal expansion. Through the special design of the structure, a surface of the device has thermal conductivity, but the interior cannot conduct heat. That is, the surface thermal conduction and the internal thermal insulation are both achieved, and an edge state and a topological protection property similar to those of an electrical topological insulator are realized in a macroscopic heat conduction process. The assembly form of the three assemblies of this topological insulation device is described in the following paragraphs:

The three assemblies are assembled on the substrate to form two different types of regions. One is an outer heat-conduction ring, and the other one is a thermal insulation region wrapped by the outer heat-conduction ring. For the topological insulation device, the outer heat-conduction ring is equivalent to the surface of the device, while the thermal insulation region is equivalent to the interior of the device. A plurality of second assemblies and a plurality of third assemblies are spliced into a ring shape sequentially to form the outer heat-conduction ring, and the thermal insulation region is formed by a plurality of the first assemblies arranged in a periodic array. The specific numbers of the first assembly, the second assembly, and the third assembly may be determined according to the actual device surface shape and are not limited thereto. As described above, in order to achieve negative thermal expansion of some assemblies, the second connection points of all assemblies in the outer heat-conduction ring and the thermal insulation region are fixed on the substrate and cannot be moved, and both the first connection point and the third connection point can move freely, so as to satisfy spatial constraints of the connection points required for each negative thermal expansion segment and positive thermal expansion segment. Further, in addition to the spatial constraints of the connection points, in order to realize the thermal topological insulation properties of surface thermal conduction and internal thermal insulation of the topological insulation device, the outer heat-conduction ring and the thermal insulation region also need to satisfy the constraints of the connection state for rod segments. That is, in the outer heat-conduction ring, any two adjacent assemblies are collinearly or parallelly connected through their positive thermal expansion segments. In the thermal insulation region, only one negative thermal expansion segment in each of any two adjacent first assemblies is collinearly connected to another. Further, one negative thermal expansion segment in each of the first assembly located at an edge of the thermal insulation region and the corresponding assembly in the outer heat-conduction ring is also collinearly connected to each other.

It should be noted that the collinear connection in the present invention means that the two rod segments are on the same straight line and their ends are in contact to form thermal conduction, while the parallel connection means that the two rod segments overlap. The definition of integration herein is as mentioned above, so description thereof is not repeated herein.

In the abovementioned constraints of the connection state for the rod segments, the two adjacent assemblies in the outer heat-conduction ring may be the second assembly adjacent to the third assembly, may be the second assembly adjacent to the second assembly, or may the third assembly adjacent to the third assembly. However, regardless of the scenario for adjacency, respective positive thermal expansion segments in each of any two adjacent assemblies are collinearly or parallelly connected. The specific use of collinear connection or parallel connection depends on the actual assembly form. Generally, non-corner positions are all collinearly connected, while corner positions may be collinearly connected or parallelly connected.

In the present invention, if the outer heat-conduction ring of the topological insulation device is a regular rectangle, then the third assembly is provided at the corner position of the outer heat-conduction ring for connection, and the remaining straight line segments are connected by the second assembly. In the entire outer heat-conduction ring, any two adjacent assemblies are collinearly connected through their respective positive thermal expansion segments. However, if the outer heat-conduction ring of the topological insulation device is not a regular rectangle but a special-shaped polygon with internal corners, then the second assembly or the third assembly is provided at the corner position of the outer heat-conduction ring for connection, and the remaining straight line segments are connected by the second assembly. In the entire outer heat-conduction ring, any two adjacent assemblies at the corner position are collinearly or parallelly connected through their positive thermal expansion segments. The specific implementation depends on connection form that is possibly realized, but all non-corner positions use collinear connection.

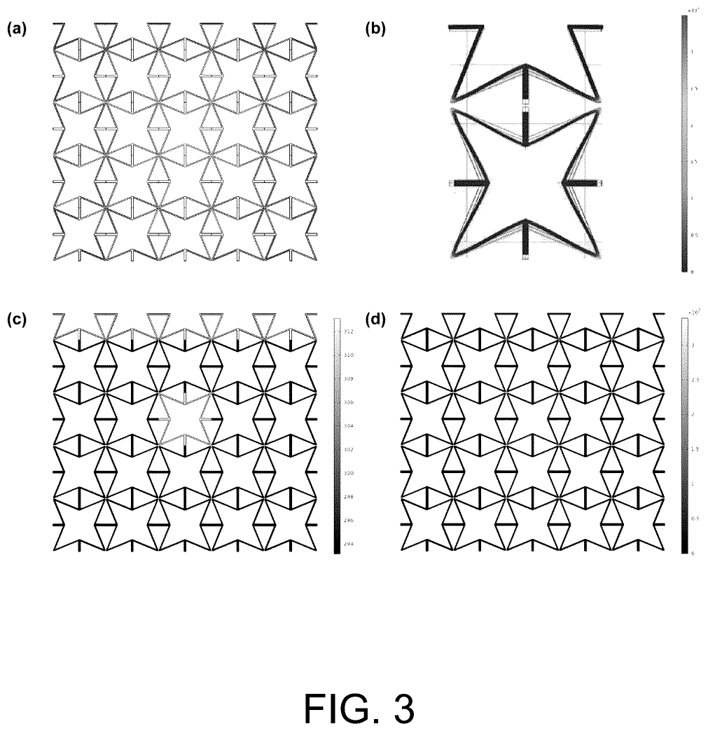

In order to verify the thermal topological insulation properties of surface thermal conduction and internal thermal insulation of the topological insulation device in the present invention, the properties of the topological insulation device are verified through finite element simulation. As shown in FIG. 3, the simulation results of some surface locations and internal regions in the entire topological insulation device are shown. As shown in (a) of FIG. 3, the second connection points of all assembly units in the entire device are fixed by adiabatic anchor points, and the surface of the device is used to simulate an interface between the device and the external vacuum. The second assembly of the five positive thermal expansion segments connected collinearly is shown, but the third assembly of the corner is not shown. The internal region of the device shows the first assembly arranged in a 5×4 rectangular array. Through the finite element simulation software COMSOL, the deformation results of the first assembly and the second assembly when the temperature increases are simulated herein, as shown in (b) of FIG. 3. The results are consistent with the results of the aforementioned theoretical analysis. That is, due to the lack of a symmetrical upper half structure, the second assembly exhibits positive thermal expansion in the x-axis direction. Since the first assembly is a complete structure and its four corners are limited, it exhibits negative thermal expansion, and the expansion coefficient is consistent with the equivalent thermal expansion coefficient expressed by formula (5). It should be noted that for the sake of visual intuition, the degree of deformation in (b) of FIG. 3 is magnified to 50 times the actual amount of deformation through software adjustment to demonstrate the thermal shrinkage of its structure.

In addition, (c) of FIG. 3 and (d) of FIG. 3 also show the temperature distribution and stress distribution of a specific unit cell when a heat source higher than the initial temperature is applied to a surface of a crystal without lattice defects and to the specific unit cell within the crystal. The stress distribution is used herein to characterize the deformation degree of the structure. According to the finite element simulation results, when a heat source higher than the initial temperature is applied to the device surface, the positive thermal expansion segment of the second assembly that is originally collinearly connected still maintains the connected conduction state, so heat can be conducted on the surface unit of the device. However, the negative thermal expansion segment of the second assembly shrinks towards the center of the second assembly when heated and is out of contact with the negative thermal expansion segment of the first assembly, so a thermal disconnection state is generated, and the heat on the surface of the device is unable to be conducted to the inside. When a heat source higher than the initial temperature is applied to the first assembly inside the device, the four negative thermal expansion segments of the first assembly are all heated and shrink toward the center of the first assembly and thus are out of contact with the negative thermal expansion segments of the surrounding first assembly. The heat input may be localized to the first assembly itself to which the temperature is applied, and a thermal insulation effect is thereby generated.

It thus can be seen that a boundary appears on the surface of the topological insulation device of the present invention, so that the first assembly with a complete structure terminates at the surface of the device and is replaced by the second assembly or the third assembly with an incomplete structure. This topological insulation device can be analogous to a crystal, in which the first assembly is an ideal complete unit cell, while the second assembly and the third assembly are defective unit cells. Taking the structure shown in (a) of FIG. 3 as an example of a crystal, due to the abrupt termination of the periodicity of the crystal lattice at the surface, the surface structure expands due to an increase in temperature in the x-axis direction, so that the adjacent units on the surface are in contact with one another and are therefore in a thermal conduction state. Inside the crystal, the absence of defects and the lack of symmetry result in periodic arrangement of unit cells, causing all unit cell structures to be in a state of negative thermal expansion. This may cause that when a high temperature source is applied to any unit cell, the structural size of the unit cell may shrink due to heat, thereby breaking contact with adjacent units. This means that inside the crystal, the heat may not diffuse internally, that is, the interior of the crystal is insulated for heat conduction, and a structure with this property is called a topological insulator based on a negative thermal expansion structure in the present invention.

Further, the abovementioned topological insulation property is theoretically explained and illustrated in the present invention:

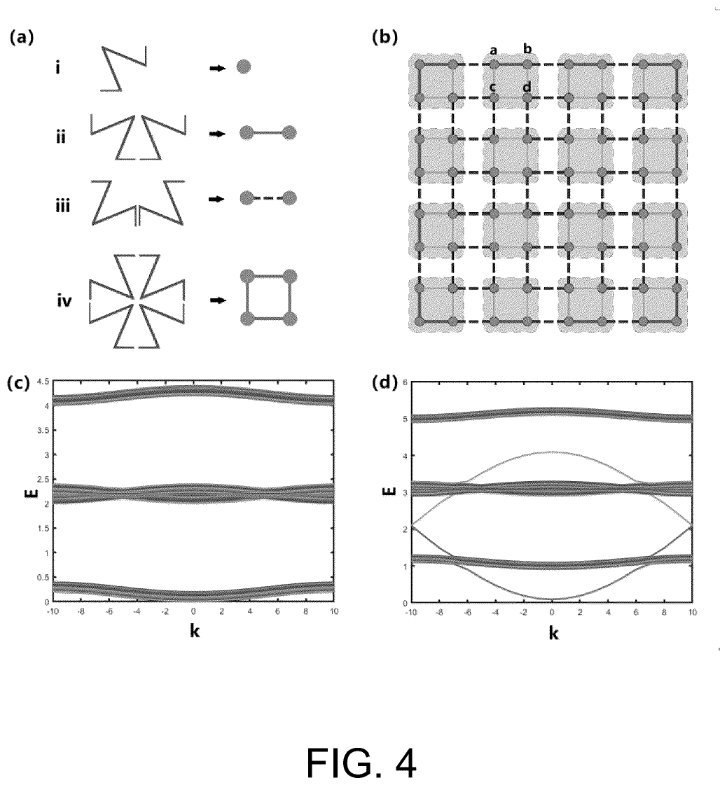

First, a Su-Schrieffer-Heeger (SSH) model is used to explain the nontrivial topology in this two-dimensional structural system. (a) of FIG. 4 shows the corresponding relationship between different combinations of assembly units and the SSH model. The assembly unit shown in i may be regarded as an “atom”, and by combining it with four 90° rotations, a new center-symmetric unit structure as shown in iv may be obtained. The structures shown in ii and iii show the atomic bond strength within and between units respectively. It should be noted that the unit in the present invention is slightly different from the typical SSH model used to describe a two-dimensional crystal lattice. Since the negative thermal expansion structure in the present invention returns to the normal thermal expansion property at the boundary, the bond strength between adjacent “atoms” in the corresponding unit may differ depending on whether the “atom” is at the body boundary. As shown in (b) of FIG. 4, the bond strength when the adjacent “atoms” in the unit are all located at the boundary is w₁, and the bond strength when they are not at the boundary is w₂. Within the structure, the bond strength between adjacent “atoms” in different units is uniformly set to v.

When the structure is completely periodic, the Hamiltonian of this SSH model is:

$$H = {\sum }_{ij} {w}_{2} ( {b}_{i , j}^{†} {a}_{i , j} + {c}_{i , j}^{†} {b}_{i , j} + {c}_{i , j}^{†} {d}_{i , j} + {d}_{i , j}^{†} {a}_{i , j} ) + {\sum }_{ij} v ( {a}_{i + 1 , j}^{†} {b}_{i , j} + {d}_{i + 1 , j}^{†} {c}_{i , j} + {b}_{i , j + 1}^{†} {c}_{i , j} + {a}_{i , j + 1}^{†} {d}_{i , j} ) + h . c . \qquad ( 6 )$$

where a, b, c, and d represent the four adjacent “atoms” in the unit, i and j represent the unit located in the i^{th} row and j^{th} column in the entire structure, the symbol “†” is “Dagger”, which represents the conjugate transpose operation, and h.c represents the contribution of the external field to the model Hamiltonian.

Then, calculating each term individually:

The first term can be written as:

$${\sum }_{i , j} {b}_{i , j}^{†} {a}_{i , j} = {\sum }_{i , j} {\sum }_{k} {b}_{k}^{†} {e}^{- i ( {k}_{x} i + {k}_{y} j )} {\sum }_{{k}^{′}} {a}_{{k}^{′}} {e}^{i ( {k}_{x}^{′} i + {k}_{y}^{′} i )} = {\sum }_{k} {b}_{k}^{†} {a}_{k} \qquad ( 7 )$$

where k represents the wave vector in the SSH model, kₓ and k_{y} represent the components of the wave vector in the x and y directions.

Calculating the second term gives:

$${\sum }_{i , j} {a}_{i + 1 , j}^{†} {b}_{i , j} = {\sum }_{i , j} {\sum }_{k} {a}_{k}^{†} {e}^{- i ( {k}_{x} ( i + 1 ) + {k}_{y} i )} {\sum }_{{k}^{′}} {b}_{{k}^{′}} {e}^{i ( {k}_{x}^{′} i + {k}_{y}^{′} j )} = {\sum }_{k} {a}_{k}^{†} {b}_{k} {e}^{- {ik}_{x}} \qquad ( 8 )$$

Through letter substitution and Fourier transformation, the form of the Hamiltonian can be simplified to:

$$H = {\sum }_{k} ( {w}_{2} + {ve}^{- {ik}_{x}} ) ( {a}_{k}^{†} {b}_{k} + {d}_{k}^{†} {c}_{k} ) + ( {w}_{2} + {ve}^{- {ik}_{y}} ) ( {b}_{k}^{†} {c}_{k} + {a}_{k}^{†} {d}_{k} ) + h . c . \qquad ( 9 )$$

For the above-mentioned Hamiltonian, convert it into matrix form:

$$H = ( \begin{matrix}0 & {w}_{2} + {ve}^{- {ik}_{x}} & 0 & {w}_{2} + {ve}^{- {ik}_{y}} \\ {w}_{2} + {ve}^{{ik}_{x}} & 0 & {w}_{2} + {ve}^{- {ik}_{y}} & 0 \\ 0 & {w}_{2} + {ve}^{{ik}_{y}} & 0 & {w}_{2} + {ve}^{{ik}_{x}} \\ {w}_{2} + {ve}^{{ik}_{y}} & 0 & {w}_{2} + {ve}^{- {ik}_{x}} & 0\end{matrix} ) \qquad ( 10 )$$

According to the Hamiltonian in the matrix form, the corresponding energy band may be calculated using the software MATLAB. The calculated energy band diagram is shown in (c) of FIG. 4, and in the calculation of this energy band, the bond strength w₂=0.1 and v=1 are assumed.

Further, assuming that the crystal has a finite number of unit cells in the x-axis direction, but still satisfies periodic boundary conditions in the y-direction, so the Hamiltonian is rewritten as:

$$H = ( \begin{matrix}A & 0 & 0 & ⋯ \\ B & A & 0 & ⋯ \\ 0 & B & A & ⋯\end{matrix} ) + {( \begin{matrix}A & 0 & 0 & ⋯ \\ B & A & 0 & ⋯ \\ 0 & B & A & ⋯\end{matrix} )}^{*} \qquad ( 11 )$$

$$where :$$

$$\begin{matrix}A = ( \begin{matrix}0 & 0 & 0 & {ve}^{- {ik}_{x}} \\ {w}_{2} & 0 & {ve}^{- {ik}_{x}} & 0 \\ 0 & {w}_{2} & 0 & {w}_{2} \\ 0 & 0 & 0 & 0\end{matrix} ) & ( 12 ) \\ B = ( \begin{matrix}0 & v & 0 & 0 \\ 0 & 0 & 0 & 0 \\ 0 & 0 & 0 & 0 \\ 0 & 0 & v & 0\end{matrix} ) & ( 13 )\end{matrix}$$

It should be noted that in the crystal of the present invention, the distribution of unit cell bond strength on the surface is uneven. Therefore, when considering that the crystal has n=10 unit cells in the x direction, the form of the matrices A₁ and A₁₀ at the upper and lower boundaries shall be rewritten as:

$$\begin{matrix}{A}_{1} = ( \begin{matrix}0 & 0 & 0 & {ve}^{- ik} \\ {w}_{1} & 0 & {ve}^{- ik} & 0 \\ 0 & {w}_{2} & 0 & {w}_{2} \\ 0 & 0 & 0 & 0\end{matrix} ) & ( 14 ) \\ {A}_{10} = ( \begin{matrix}0 & 0 & 0 & {ve}^{- ik} \\ {w}_{2} & 0 & {ve}^{- ik} & 0 \\ 0 & {w}_{2} & 0 & {w}_{1} \\ 0 & 0 & 0 & 0\end{matrix} ) & ( 15 )\end{matrix}$$

After this processing, a semi-periodic crystal energy band diagram may be obtained using the same algorithm as the crystal with completely periodic boundary conditions, as shown in (d) of FIG. 4. This result shows that boundary states appear in the energy band, and two edge state energy levels that do not appear in the full cycle case appear in the figure.

It should be noted that the above finite element simulations and theoretical explanations are both to better illustrate the principles and properties of the topological insulation device with negative thermal expansion of the present invention, but the examples are given for the ease of description and should not be understood as limitations of the present invention.

In addition, the abovementioned topological insulation device with negative thermal expansion has the thermal topological insulation properties of surface thermal conduction and internal thermal insulation, and the conduction and insulation properties are both relative to heat. However, in a preferred embodiment of the present invention, the abovementioned topological insulation device with respect to heat may be converted into an electrical topological insulation device. This electrical topological insulation device also has the thermal topological insulation properties of surface thermal conduction and internal thermal insulation, and it also has electrical topological insulation properties, that is, a surface of the device is conductive and the interior is electrically insulated. A structural form of this electrical topological insulation device is basically the same as the aforementioned topological insulation device, and only materials of the first rod segment, the second rod segment, the third rod segment, and the fourth rod segment need to be adjusted. To be specific, surfaces of the first rod segment, the second rod segment, the third rod segment, and the fourth rod segment are all conductive, and each rod segment generates Joule heat after conduction. Further, it should be ensured that the substrate should not only be non-conductive of heat but also non-conductive of electricity. In this electrical topological insulation device, the Joule heat generated by the thermal effect of the current is used, the Joule heating generated by the current may cause the geometry of the structure to respond, and then the thermal topological insulation properties are realized, and the electrical topological insulation properties are thus simultaneously produced. Obviously, the temperature increase caused by Joule heating allows current to easily pass on the device surface and exhibits an insulating state within the device body. Therefore, temperature and direct current may be coupled together in the present invention since they have the same effect on the topological insulation properties of the device.

Therefore, in the abovementioned electrical topological insulation device, the materials used in the first rod segment, the second rod segment, the third rod segment, and the fourth rod segment should be conductive on the surface and have a sufficient linear expansion coefficient, and there is no limit on whether the rod segments are conductive inside. In a preferred embodiment of the present invention, the first rod segment, the second rod segment, the third rod segment, and the fourth rod segment are all made of a multi-layer composite material, and the composite material uses a thermal expansion material as a skeleton and wraps a conductive layer outside the skeleton. Herein, the materials of the thermal expansion material and the conductive layer are not limited. In the present invention, the thermal expansion material may be nickel alloy, copper alloy, or nylon, etc., and is preferably nylon with a large linear expansion coefficient. The conductive layer on the surface of the skeleton is graphene paint coated on the skeleton, which can be conductive tape wrapped around the skeleton, and certainly can also be a combination of graphene paint and conductive tape. That is, a layer of graphene paint is sprayed first, and then conductive tape is wrapped on the outside.

In addition, it should be noted that in each of the above-mentioned topological insulation devices, although the first assembly, the second assembly, and the third assembly are described in the form of different combinations of assembly units, this is only for ease of description and does not limit the corresponding assemblies to the need to process independent assembly units first and then assemble the assembly units into corresponding assemblies. In fact, the first assembly, the second assembly, and the third assembly may all be formed through integrated processing, and the first rod segment and the fourth rod segment in the negative thermal expansion segments are non-spliced integrated rod segments in this approach. Considering the feasibility of the processing technology, the first assembly, the second assembly, and the third assembly are all preferably formed through processing using a 3D printing process.

Certainly, the first assembly, the second assembly, and the third assembly may also be formed by adopting the method of first processing independent assembly units and then assembling the assembly units, which is not limited.

The aforementioned theoretical derivation is combined with the finite element simulation results in the following paragraphs to verify the thermal topological insulation property and electrical topological insulation property of the above electrical topological insulation device provided by the present invention through experiments in specific examples. In this specific example, the rod segment material is first selected. According to previous theoretical derivation and finite element simulation results, the rod segment material required by the present invention is required to have a high thermal expansion rate. Further, due to the need to utilize the Joule heating effect, the material used to prepare the rod segments must also be electrically conductive. Among various natural materials that are easy to process, materials with higher thermal expansion coefficients, such as various high molecular polymers, are usually insulating. Among conductive materials, various alloy materials (nickel alloys, copper alloys, etc.) have relatively smaller linear expansion coefficients compared to various organic materials. Therefore, in order to obtain a more obvious experimental effect, this example chooses to use different types of materials to compositely form the required rod segments. Nylon is chosen as the skeleton material because the thermal expansion coefficient of nylon is an order of magnitude larger than that of copper alloy, which has a larger expansion coefficient among metals. Generally, nylon materials are not suitable for processing by ordinary machining methods, but due to the booming 3D printing technology in recent years, a large number of nylon material skeletons can be obtained relatively easily. Moreover, in order to solve the problem of non-conductivity of nylon materials, graphene paint is used to spray-paint the nylon skeleton, and since the graphene material has good electrical conductivity, the surface of the nylon skeleton with the graphene coating attached has good electrical conductivity. In this way, we obtain a composite rod segment with both a large thermal expansion coefficient and good electrical conductivity to prepare the topological insulation device. The structure of the entire topological insulation device sample is shown in FIG. 4, and the device has a concave-shaped boundary to more clearly demonstrate its heat transfer/electrical conduction boundary state.

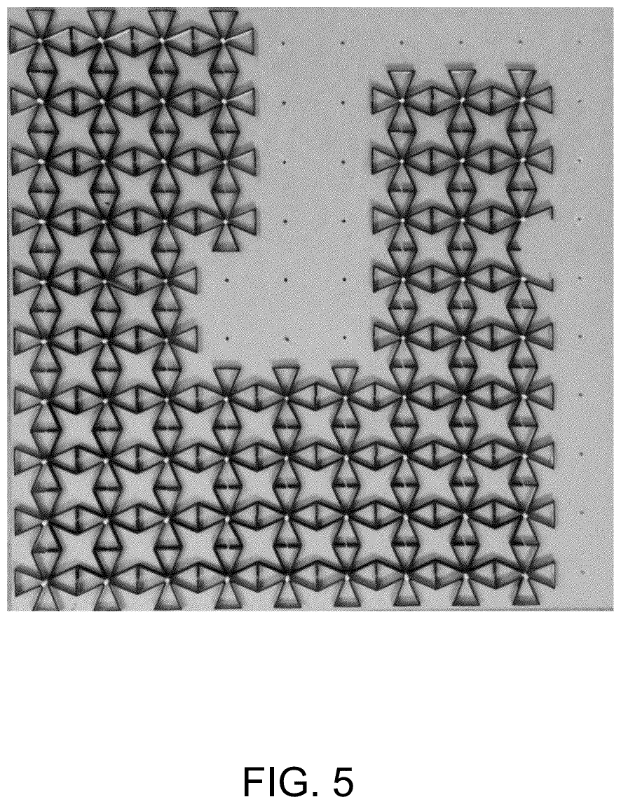

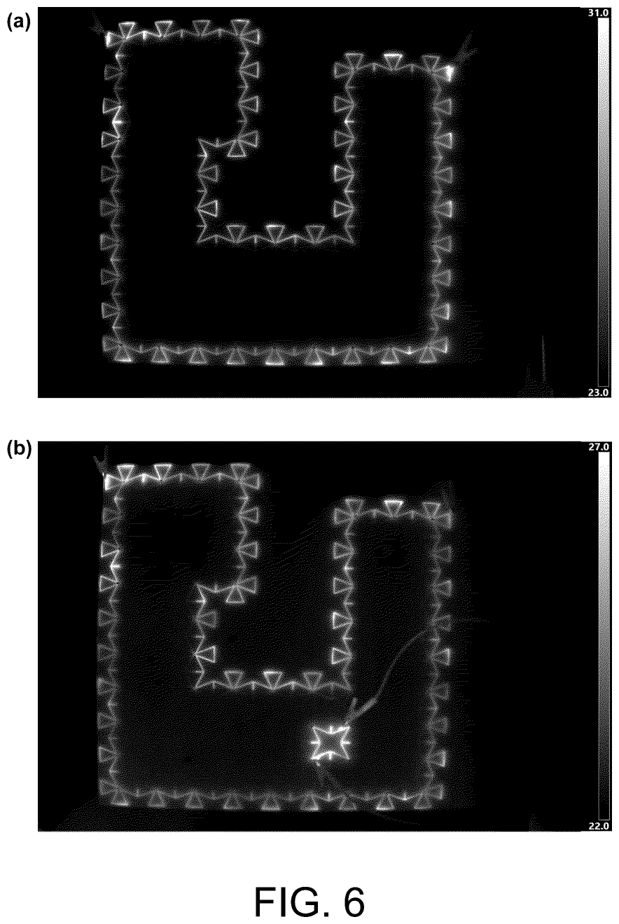

Next, the constant current source electrode is connected to the upper left corner and the upper right corner units of the outer heat-conduction ring of the topological insulation device sample in FIG. 5, and a current of 1 A is applied. After that, the temperature change of the entire sample is observed using the 348 infrared thermal imager produced by Fotric Company, and the results are shown in (a) of FIG. 6. It can be clearly found that the temperature at the boundary of the sample is significantly higher than the background and the temperature inside the sample, and heat and current are only limited to the surface of the device and are not conducted to the interior of the device.

In order to confirm that the first assemblies in the internal thermal insulation region of the sample topological insulation device exhibit insulator properties, an internal first assembly is selected and a current of 1 A is applied to it, and the temperature spread was observed. he results are shown in (b) of FIG. 6, and it can be found that the temperature of the first assembly to which current is applied increases significantly, but the temperature and current do not spread to the adjacent first assembly, but are localized on the first assembly.

The above results prove that the design of the thermomechanical metatopological insulator of the present invention has relevant properties similar to electrical topological insulators.

It should be noted that the corresponding operating temperature of each of the above topological insulation devices can be set according to the actual application scenario. When the temperature of the device is not higher than the working temperature, it is in a non-working state, and when the temperature of the device is higher than the working temperature, it can enter the working state. Therefore, this working temperature is equivalent to a temperature threshold. Regarding the outer heat-conduction ring and the thermal insulation region, each gap between any two assemblies collinearly connected through the negative thermal expansion segments is conductive and controlled based on the temperature threshold. When temperatures of the two assemblies themselves are not higher than the temperature threshold, the two negative thermal expansion segments are collinearly connected and are in a thermal conduction state, and when the temperatures of the two assemblies themselves are higher than the temperature threshold, the two negative thermal expansion segments that are collinearly connected originally are separated and are in a thermal disconnection state. As a preferred implementation method, this temperature threshold may be set to room temperature, so that the device may have thermal topological insulation properties as soon as it is produced, and can be used in industry to achieve thermal insulation protection for heat-sensitive devices.

Besides, the electrical topological insulation device in the present invention has the advantages of reconfigurability and controllable local conduction, and thus is able to provide a unified integrated solution for the changeable circuit layout in industry.

The above-described embodiments are only preferred solutions of the present invention, but the embodiments are not intended to limit the present invention. A person having ordinary skill in the art can also make various changes and modifications without departing from the spirit and scope of the present invention. Therefore, any technical solutions obtained by equivalent substitution or equivalent transformation fall within the protection scope of the present invention.

What is claimed is:

1. A topological insulation device having negative thermal expansion, comprising a plurality of first assemblies, a plurality of second assemblies, a plurality of third assemblies, and a substrate that is heat-insulating, three types of assemblies comprising the plurality of first assemblies, the plurality of second assemblies and the plurality of third assemblies being constructed by different numbers of assembly units,
each of the assembly units being a broken-line-shaped structure formed by a first rod segment, a second rod segment, a third rod segment, and a fourth rod segment connected in sequence, and the first rod segment, the second rod segment, the third rod segment and the fourth rod segment all having positive thermal expansion and having a same linear expansion coefficient, wherein one end of the first rod segment is a free end, another end of the first rod segment is connected to one end of the second rod segment through a first connection point, another end of the second rod segment is connected to one end of the third rod segment through a second connection point, another end of the third rod segment is connected to one end of the fourth rod segment through a third connection point, another end of the fourth rod segment is a free end, In a non-working state, the first rod segment and the second rod segment are mirror symmetrical to the third rod segment and the fourth rod segment respectively, the free end of the first rod segment, the second connection point, and the free end of the fourth rod segment are located at three corner points of a square, and the first rod segment and the fourth rod segment are located on two adjacent sides of the square respectively,
each of the plurality of first assemblies is formed by four of the assembly units spliced into a centrosymmetric structure, wherein the first rod segment of any of the four assembly units is integrated with and is connected to the fourth rod segment of an adjacent one of the four assembly units as a whole to act as a negative thermal expansion segment,
each of the plurality of second assemblies is formed by two of the assembly units spliced into a mirror-symmetric structure, wherein the first rod segment of one of the two assembly units is integrated with and is connected to the fourth rod segment of an adjacent one of the two assembly units as a whole to act as a negative thermal expansion segment, and the first rod segment and the fourth rod segment that are unconnected in each of the two assembly units both act as positive thermal expansion segments,
each of the plurality of third assemblies is formed by a single one of the assembly units, in which the first rod segment and the fourth rod segment of the single one assembly unit both act as positive thermal expansion segments,
the three types of assemblies are assembled on the substrate to form an outer heat-conduction ring and a thermal insulation region wrapped by the outer heat-conduction ring, the plurality of second assemblies and the plurality of third assemblies are spliced into a ring shape sequentially to form the outer heat-conduction ring, the thermal insulation region is formed by the plurality of the first assemblies arranged in a periodic array, second connection points of all the three types of assemblies in the outer heat-conduction ring and the thermal insulation region are fixed on the substrate and are unable to move, first connection points and third connection points of the three types of assemblies are allowed to move freely; in the outer heat-conduction ring, any two adjacent ones of the assemblies are collinearly or parallelly connected through their positive thermal expansion segments; in the thermal insulation region, only one negative thermal expansion segment in each of any two adjacent ones of the first assemblies is collinearly connected to another only one negative thermal expansion segment, and one negative thermal expansion segment in each of the first assemblies located at an edge of the thermal insulation region and a corresponding one of the assemblies in the outer heat-conduction ring is collinearly connected to each other.

2. The topological insulation device having negative thermal expansion according to claim 1, wherein in the outer heat-conduction ring, the plurality of third assemblies are provided at corner positions for connection, while remaining straight line segments of the outer heat-conduction ring are connected by the plurality of second assemblies.

3. The topological insulation device having negative thermal expansion according to claim 1, wherein surfaces of the first rod segment, the second rod segment, the third rod segment, and the fourth rod segment are all conductive, each of the first rod segment, the second rod segment, the third rod segment and the fourth rod segment generates Joule heat after conduction, and the substrate is not conductive.

4. The topological insulation device having negative thermal expansion according to claim 3, wherein the first rod segment, the second rod segment, the third rod segment, and the fourth rod segment are all made of a multi-layer composite material, and a skeleton of the multi-layer composite material is made of a thermal expansion material, and a conductive layer is wrapped outside the skeleton.

5. The topological insulation device having negative thermal expansion according to claim 4, wherein that the thermal expansion material is nickel alloy, copper alloy, or nylon.

6. The topological insulation device having negative thermal expansion according to claim 4, wherein the conductive layer is graphene paint coated on the skeleton and/or conductive tape wrapped around the skeleton.

7. The topological insulation device having negative thermal expansion according to claim 1, wherein the plurality of first assemblies, the plurality of second assemblies, and the plurality of third assemblies are all formed through integrated processing, and the first rod segment and the fourth rod segment in negative thermal expansion segments are non-spliced integrated rod segments.

8. The topological insulation device having negative thermal expansion according to claim 7, wherein the plurality of first assemblies, the plurality of second assemblies, and the plurality of third assemblies are all processed using 3D printing technology.

9. The topological insulation device having negative thermal expansion according to claim 1, wherein in the outer heat-conduction ring and the thermal insulation region, a gap between any two of the assemblies collinearly connected through negative thermal expansion segments is under conductance control based on a temperature threshold, when temperatures of the any two of the assemblies are not higher than the temperature threshold, two negative thermal expansion segments collinearly connected are in a thermal conduction state, and when the temperatures of the any two of the assemblies are higher than the temperature threshold, the two negative thermal expansion segments that are collinearly connected originally are separated and are in a thermal disconnection state.

10. The topological insulation device having negative thermal expansion according to claim 2, wherein in the outer heat-conduction ring and the thermal insulation region, a gap between any two of the assemblies collinearly connected through negative thermal expansion segments is under conductance control based on a temperature threshold, when temperatures of the any two of the assemblies are not higher than the temperature threshold, two negative thermal expansion segments collinearly connected are in a thermal conduction state, and when the temperatures of the any two of the assemblies are higher than the temperature threshold, the two negative thermal expansion segments that are collinearly connected originally are separated and are in a thermal disconnection state.

11. The topological insulation device having negative thermal expansion according to claim 3, wherein in the outer heat-conduction ring and the thermal insulation region, a gap between any two of the assemblies collinearly connected through negative thermal expansion segments is under conductance control based on a temperature threshold, when temperatures of the any two of the assemblies are not higher than the temperature threshold, two negative thermal expansion segments collinearly connected are in a thermal conduction state, and when the temperatures of the any two of the assemblies are higher than the temperature threshold, the two negative thermal expansion segments that are collinearly connected originally are separated and are in a thermal disconnection state.

12. The topological insulation device having negative thermal expansion according to claim 4, wherein in the outer heat-conduction ring and the thermal insulation region, a gap between any two of the assemblies collinearly connected through negative thermal expansion segments is under conductance control based on a temperature threshold, when temperatures of the any two of the assemblies are not higher than the temperature threshold, two negative thermal expansion segments collinearly connected are in a thermal conduction state, and when the temperatures of the any two of the assemblies are higher than the temperature threshold, the two negative thermal expansion segments that are collinearly connected originally are separated and are in a thermal disconnection state.

13. The topological insulation device having negative thermal expansion according to claim 5, wherein in the outer heat-conduction ring and the thermal insulation region, a gap between any two of the assemblies collinearly connected through negative thermal expansion segments is under conductance control based on a temperature threshold, when temperatures of the any two of the assemblies are not higher than the temperature threshold, two negative thermal expansion segments collinearly connected are in a thermal conduction state, and when the temperatures of the any two of the assemblies are higher than the temperature threshold, the two negative thermal expansion segments that are collinearly connected originally are separated and are in a thermal disconnection state.

14. The topological insulation device having negative thermal expansion according to claim 6, wherein in the outer heat-conduction ring and the thermal insulation region, a gap between any two of the assemblies collinearly connected through negative thermal expansion segments is under conductance control based on a temperature threshold, when temperatures of the any two of the assemblies are not higher than the temperature threshold, two negative thermal expansion segments collinearly connected are in a thermal conduction state, and when the temperatures of the any two of the assemblies are higher than the temperature threshold, the two negative thermal expansion segments that are collinearly connected originally are separated and are in a thermal disconnection state.

15. The topological insulation device having negative thermal expansion according to claim 7, wherein in the outer heat-conduction ring and the thermal insulation region, a gap between any two of the assemblies collinearly connected through negative thermal expansion segments is under conductance control based on a temperature threshold, when temperatures of the any two of the assemblies are not higher than the temperature threshold, two negative thermal expansion segments collinearly connected are in a thermal conduction state, and when the temperatures of the any two of the assemblies are higher than the temperature threshold, the two negative thermal expansion segments that are collinearly connected originally are separated and are in a thermal disconnection state.

16. The topological insulation device having negative thermal expansion according to claim 8, wherein in the outer heat-conduction ring and the thermal insulation region, a gap between any two of the assemblies collinearly connected through negative thermal expansion segments is under conductance control based on a temperature threshold, when temperatures of the any two of the assemblies are not higher than the temperature threshold, two negative thermal expansion segments collinearly connected are in a thermal conduction state, and when the temperatures of the any two of the assemblies are higher than the temperature threshold, the two negative thermal expansion segments that are collinearly connected originally are separated and are in a thermal disconnection state.

17. The topological insulation device having negative thermal expansion according to claim 9, wherein the temperature threshold is a room temperature.
